(19) United States
(12) Patent Application Publication
(10) Pub. No.: US 2010/0154062 A1
(43) Pub. Date: Jun. 17, 2010

(54) Virus Scanning Executed Within a Storage Device to Reduce Demand on Host Resources

(76) Inventors: Elad Baram, Shilat Village (IL); Yacov Duzly, Ra'anana (IL)

Correspondence Address: BRINKS HOFER GILSON & LIONE/SanDisk, P.O. BOX 10395, CHICAGO, IL, 60610, US

(21) Appl. No.: 12/336,310

(22) Filed: Dec. 16, 2008

(51) Int. Cl. G06F 21/22

(52) U.S. Cl. 726/24

(57) ABSTRACT

Protection against computer viruses is provided by a storage device having a memory, a controller, and a content scanning module used for scanning files for viruses. Infected files are indicated to a virus handling module that resides external to the storage device. The virus handling module may alter access to the infected files and/or indicate their presence to other system components. Such virus scanning mechanism can be built within the controller of the storage device. The protection against computer viruses may be provided by a method that includes transferring file data from the memory to the controller, reconstructing the files from the file data, activating the controller to check the reconstructed files for viruses, and indicating the infected files to the virus handling module. By using the controller within the storage device to scan for viruses, the burden on the host can be greatly reduced.

### BACKGROUND

When receiving input from external sources, data processing apparatuses such as personal computers and mobile telephone are vulnerable to attack by malicious software often referred to as “computer viruses” or simply “viruses.” As an example, a personal computer may receive a virus when downloading software from the Internet, and the virus may attempt to reformat the hard drive of the personal computer. As another example, a mobile telephone may unknowingly receive a virus that deletes its address book.

The threat of damage from viruses has grown with time and consequently much effort has been invested in developing antivirus utilities. Antivirus utilities typically include a content scanning module and a virus handling module. The content scanning module checks whether files of a host system have characteristic byte-patterns or “signatures.” These signatures are stored in a frequently-updated database that the content scanning module accesses. If such a virus signature is found in a file, the content scanning module indicates the file containing the virus signature to the virus handling module so that the virus handling module will process the infected file in various ways.

For example, the virus handling module may process the infected file by altering access to it by the host system by deleting and/or otherwise altering access rights to the file, such as by quarantining. Alternatively, the content scanning module may indicate the file by identifying the virus signature to the virus handling module, which in turn modifies the file to remove the virus. The virus handling module may indicate the presence of the infected file to the host system and/or to the user, for example, by flashing a message on a display of the host and/or sounding an audible alarm. The virus handling module may indicate the presence of the infected file by setting an internal flag to show the presence of the infected file to an inquiring algorithm.

FIG. 1 provides a block diagram of a conventional system 10 that includes an antivirus utility. In one scenario, a host 12 includes a controller 12 that executes a content scanning module 14 and a virus handling module 16 to protect files stored on a hard disk drive 18 of the system 10. The content scanning module 14 references a virus signature database 20 as discussed above. To access individual files of the hard disk drive 18 for scanning by the content scanning module 14 and for handling by the virus handling module 16, the controller 12 first accesses a file system 22 that in turn accesses a device driver 24 to retrieve the data of the files. After the device driver 24 returns the data to the file system 22, the file system 22 reconstructs the individual files for the content scanning module 14 to scan and, if a virus is found thereon, for the virus handling module 16 to process.

The present inventors have observed that, while it is tolerable to allocate resources for executing a virus handling module, executing a content scanning module is typically much more resource-intensive. With the increases in storage sizes that have become available over the years for data processing apparatuses comes a corresponding increase in the resources required to scan all the content stored in those data processing apparatuses. An example effect of this phenomenon in a mobile telephone is the diversion of resources used to scan the large-sized storage, the diversion detracting from the user experience by causing the user to wait longer when changing display menus or when searching for stored telephone numbers. Nonetheless, because high priority is typically accorded to protecting the integrity of data, sufficient resources for executing content scanning modules are reluctantly allocated.

The load on the controller 12 becomes even more significant when files on additional storage devices are also checked for viruses. Such burdens on processing resources occur frequently, because many hosts are designed to accommodate for example universal serial bus (USB) flash drives (UFDs) and/or solid state drives (SSDs).

Referring back to FIG. 1, the system 10 includes a peripheral storage device 26. For the content scanning module 14 to check files stored on the storage device 26 for viruses, the controller 12 accesses the file system 22 that in turn accesses a device driver 28 to retrieve the files. The host 12 has an interface 30 that connects to an interface 32 of the storage device. The device driver 28 accesses the file data in the storage device 26 via the interfaces 30, 32.

Multiple factors account for the increased load on the controller 12 that is caused by the peripheral storage device 26. One factor is simply that the addition of any storage device containing file data creates additional files for the content scanning module 14 to check. An added factor is that, if the storage device 26 is frequently disconnected and reconnected, as is often the case for peripherals such as UFDs, the content scanning module 14 needs to repeat much of its processing if it is programmed to recheck every file stored thereon upon reconnection even after a only a brief period of disconnection in order to ensure that a previously-checked file has not been infected since it was last checked by the virus handling module 16. An alternative to rechecking every file could be to provide an elaborate tracking method to limit the rechecking to only those files that have been added or modified since the last time the storage device 26 was connected to the host 12, but this alternative would also require processing resources.

Because the practice of frequently disconnecting and reconnecting storage devices to hosts is so wide-spread, the demand on processing resources to guard against viruses remains high. Accordingly, users of data processing apparatuses employing antivirus utilities would benefit from an alternate way to scan files for viruses that relieves the host of some of the more resource-intensive tasks.

### SUMMARY

The present invention enables the scanning of files for viruses in a storage device while minimizing the burden upon the controller of the host. The burden on the host is reduced by using an internal controller within a storage device to execute a content scanning module residing therein. Thus, for protection against viruses stored on such storage device, the host controller needs only to receive notification from the storage device of any detected infected files, and then the host controller executes the less resource-intensive virus handling module. The invention may be embodied as storage device, a controller for a storage device, or a method of scanning for viruses within a storage device.

One storage device embodying the invention is for a host that has a host controller. The storage device has a memory, a storage device controller, and a content scanning module. The memory, which may be a non-volatile memory, such as a flash memory, is configured to store file data. The storage device controller is configured to aid in the execution of read, write, and erase operations on files reconstructed from the file data. The content scanning module is configured for execution by the storage device controller (1) to scan the files with reference to a database of virus signatures to find files infected with viruses and (2) to indicate the infected files to a virus handling module that resides external to the storage device. The storage device may be configured to include the database of virus signatures referenced by the content scanning module. Alternatively, the database of virus signatures referenced by the content scanning module may reside in another storage device that is peripheral to the host.

The virus handling module is configured to process the infected files by (1) altering access of the host to the infected files, (2) modifying the infected files, and/or (3) indicating the presence of the infected files. The virus handling module may be configured to reside on the host and to be executed by the host controller. Also, the virus handling module may be configured to alter the access of the host to the infected files by deleting the infected files and/or by modifying the access rights of the infected files.

The storage device may also include a file management system that is configured for utilization by the storage device controller to read sectors of the non-volatile memory and to reconstruct the files for the content scanning module to scan.

A storage device for a host having a host controller may embody the invention by having memory means for storing file data, controller means for aiding in the execution of read, write, and erase operations on files reconstructed from the file data, and content scanning means. The content scanning means, which is configured for execution by the controller means, is (1) for scanning the files with reference to a database of virus signatures to find files infected with viruses and (2) for indicating the infected files to a virus handling means that resides external to the storage device. The storage device may be configured to include the database of virus signatures referenced by the content scanning means. Alternatively, the database of virus signatures referenced by the content scanning means may reside in another storage device that is peripheral to the host.

The virus handling means for this storage device is a means for processing the infected files by (1) altering access of the host to the infected files, (2) modifying the infected files, and/or (3) indicating the presence of the infected files. The virus handling means may be configured to reside on the host and to be executed by the host controller.

The storage device of this embodiment may also include a file management means that is configured for utilization by the controller means for reading sectors of the memory means and for reconstructing files for the content scanning means to scan.

One controller embodying the invention is for a storage device and has a first interface, a second interface, a content scanning module, and a processor. The first interface is for communication with a host of the storage device, the host having a host controller. The second interface is for communication with a memory that is configured to store file data. The memory may be a non-volatile memory, such as a flash memory. The content scanning module is configured (1) to scan files reconstructed from the file data with reference to a database of virus signatures to find files infected with viruses and (2) to indicate the infected files to a virus handling module that resides external to the storage device. The controller may be configured to include the database of virus signatures referenced by the content scanning module. Alternatively, the database of virus signatures referenced by the content scanning module may reside in another storage device that is peripheral to the host. The processor is configured (1) to execute read, write, and erase operations on the files and (2) to execute the content scanning module.

The virus handling module of the controller is configured to process the infected files, the processing (1) altering access of the host to the infected files, (2) modifying the infected files, and/or (3) indicating to a user of the storage device the presence of the infected files. The virus handling module may be configured to reside on the host and be executed by the host controller. Also, the virus handling module may be configured to alter the access of the host to the infected files by deleting the infected files and/or by modifying the access rights of the infected files.

The controller for a storage device may also include a file management system configured for utilization by the processor to read sectors of the non-volatile memory and to reconstruct the files for the content scanning module to scan.

One method embodying this invention is a method of scanning for viruses within a storage device having a controller and a memory, which may be a non-volatile memory, such as a flash memory. The method includes transferring file data from the memory to the controller, reconstructing files from the file data, activating the controller to check the files for virus infections, and indicating infected files to a virus handling module that is external to the storage device. The reconstructing of the files from the file data may be performed by the controller within the storage device. The activating of the controller to check the files for virus infections may include accessing a database of virus signatures that resides in the storage device. Alternatively, the activating of the controller to check the files for virus infections may include accessing a database of virus signatures that resides in another storage device that is separate from a host of the first storage device.

The virus handling module of this method is configured to (1) alter access of host of the storage device to the infected files, (2) modify the infected files, and/or (3) indicate to a user of the storage device the presence of the infected files.

Embodiments of the present invention are described in detail below with reference to the accompanying drawings, which are briefly described as follows:

### BRIEF DESCRIPTION OF THE DRAWINGS

The invention is described below in the appended claims, which are read in view of the accompanying description including the following drawings, wherein:

FIG. 1 illustrates a prior art system that implements an antivirus utility;

FIG. 2 illustrates system in which a storage device implements an antivirus utility according to a first embodiment of the invention;

FIG. 3 illustrates a controller that implements an antivirus utility according to a second embodiment of the invention;

FIG. 4 illustrates a system that implements an antivirus utility according to a third embodiment of the invention; and

FIG. 5 presents a flow chart that represents a method of scanning for viruses according to a fifth embodiment of the invention.

### DETAILED DESCRIPTION

The invention summarized above and defined by the claims below will be better understood by referring to the present detailed description of embodiments of the invention. This description is not intended to limit the scope of claims but instead to provide examples of the invention. Described first are storage devices that embody the invention. Then described are controllers of storage devices that that embody the invention. After that, methods are described that embody the invention.

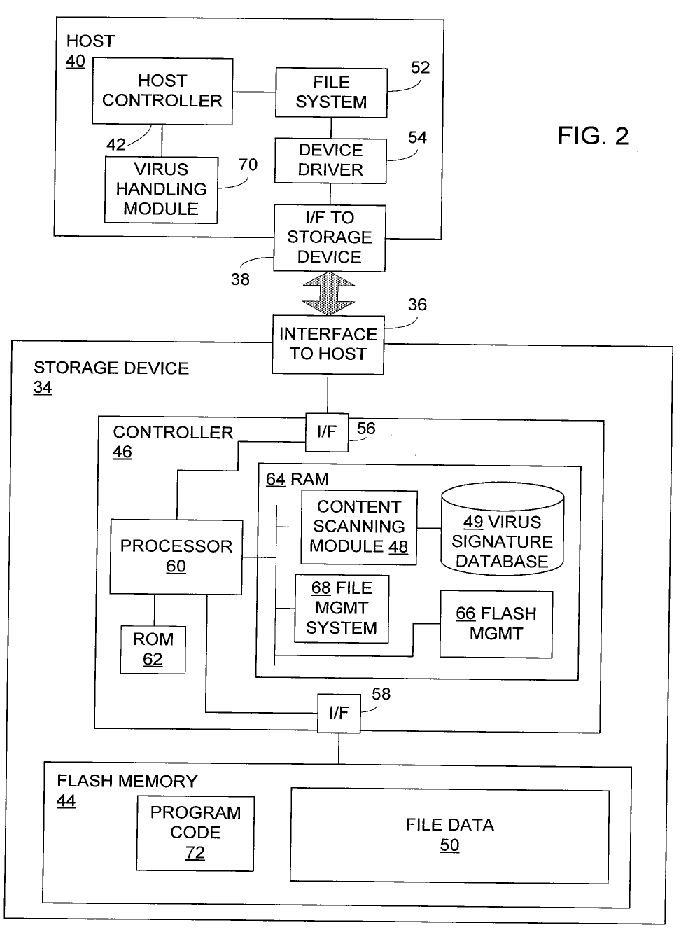

The invention may be embodied as a storage device as shown in FIG. 2. A storage device 34 for storing files has an interface 36 for operationally connecting to an interface 38 of a host 40. In this example, the host 40 is a personal computer that has a controller 42, and the storage device 34 is a UFD configured to implement the USB mass storage device standard for communication with the host 40. The interface 36 is a USB plug, and the interface 38 is a USB port. Note that although a personal computer and a UFD are in the present example embodying the invention, the invention is not limited accordingly. For example, the invention may be embodied as a micro SD card operationally connecting to a mobile telephone.

The storage device 34 has a flash memory 44, a controller 46, and a content scanning module 48. The flash memory 44 stores file data 50 that is reconstructed to form the files stored on the storage device 34. The controller 46 is configured to aid in the execution of read, write, and erase operations on those files as directed by the host controller 42 of the host 40 when the host controller 42 sends read, write, and erase commands, respectively.

More specifically, when an application, such as a text editor, run by the host controller 42 issues a read, write, or erase command that affects a file constituted by the data 50 stored on the storage device 34, the host controller 42 accesses a host file system 52 that in turn accesses a host device driver 54 to retrieve the data of the file using the storage device controller 46. The file system 52 reconstructs the file from the retrieved data so that the host controller 42 may complete execution of the read, write, or erase command originating from the application. Thus, in this capacity the storage device controller 46 aids in the execution of the various commands.

The host 40 connects to the storage device 34 at the interfaces 36, 38. The host device driver 54 communicates with the storage device controller 46, which retrieves data from and stores data on the flash memory 44. The controller 46 has an interface 56 for communication with the interface 36 and thus to the host 40, and the controller has another interface 58 for communication with the flash memory 44. Within the controller is a processor 60 that sends and receives signals through both interfaces 56, 58. The processor 60 also communicates with a read-only memory (ROM) 62 and a random-access memory (RAM) 64 that are elements of the controller 46. In operation, flash management code 66 resides in RAM 64, and the processor 60 runs this code when the controller 46 retrieves data from and stores data in the flash memory 44.

Also residing in RAM 64 during operation are the content scanning module 48 and an associated virus signature database 49, which has characteristic byte-patterns of viruses as discussed above. The content scanning module 48 references the virus signature database 49 to scan for viruses in files reconstructed from the file data 50. However, without using host resources, such as the host controller 42 and the host file system 52, the processor 60 utilizes a file management system 68, also residing within RAM 64, to read the file data 50 in sectors of the flash memory 44 and to reconstruct the files for the content scanning module 48 to scan.

The file management system 68 is configured similarly to a complete file system. In this embodiment, the file management system 68 performs functions for reading files but does not write or erase files as does a complete file system. In other embodiments, though, the file management system could include those functions if desired. The file management system may also be any other equivalent means, configured for utilization by a controller, for reading sectors of a memory and for reconstructing files for a content scanning module to scan.

Thus, for protection against viruses stored on the peripheral storage device 34, the host controller 42 does not need to execute a resource-intensive content scanning module. Instead, the host controller 42 needs only to receive notification from the storage device 34 of any detected infected files, and the content scanning module 48 of the present embodiment provides that notification by indicating the infected files to a less resource-intensive virus handling module 70 residing on the host 40 that the host controller 42 executes for processing infected files in various ways.

For example, the virus handling module 70 may process an infected file by altering the access of the host 40 to the file by the modifying access rights to the file, such as by deleting or quarantining it. Alternatively, if the content scanning module 48 is programmed to indicate the infected file by identifying the associated virus signature, the virus handling module 70 may modify the infected file to remove the virus. As another alternative, the virus handling module 70 may indicate the presence of the infected file to the host 40 and/or to the user, for example, by flashing a message on a display of the host 40 and/or sounding an audible alarm. Also, the virus handling module 70 may indicate the presence of the infected file by setting an internal flag to show the presence of the infected file to an inquiring algorithm. The virus handling module may be any other equivalent means for processing the infected files by (1) altering access of a host to the infected files, (2) modifying the infected files, and/or (3) indicating the presence of the infected files. Alternatively, an embodiment may have a virus handling module configured to reside external to both the storage device and the host without departing from the scope of the invention.

The content scanning module 48 may be programmed to maintain in the storage device 34 a history of files scanned. Then, if the storage device 34 is disconnected and later reconnected to the host 40, the content scanning module can reference this history so as not to use resources to rescan any files that were not added or modified since the last scan. Thus, even if the storage is disconnected from the storage device 34 and connected to another storage device, the content scanning module would not need to rescan unmodified files upon connection to a host.

During operation of the present embodiment, the content scanning module 48, the virus signature database 49, the flash management software 66, and the file management system 68 reside in RAM 64. Because the RAM 64 is volatile, the logic does not remain in RAM 64 when the storage device 34 has no power, for example, after the storage device 34 is disconnected to the host 40. When power to the storage device 34 is resumed, the processor 60 of the controller 46 accesses logic in the ROM 62 which causes the processor 60 to retrieve program code 72 stored in the flash memory 44 to load into RAM 64 the logic and data representing the content scanning module 48, the virus signature database 49, the flash management software 66, and the file management system 68.

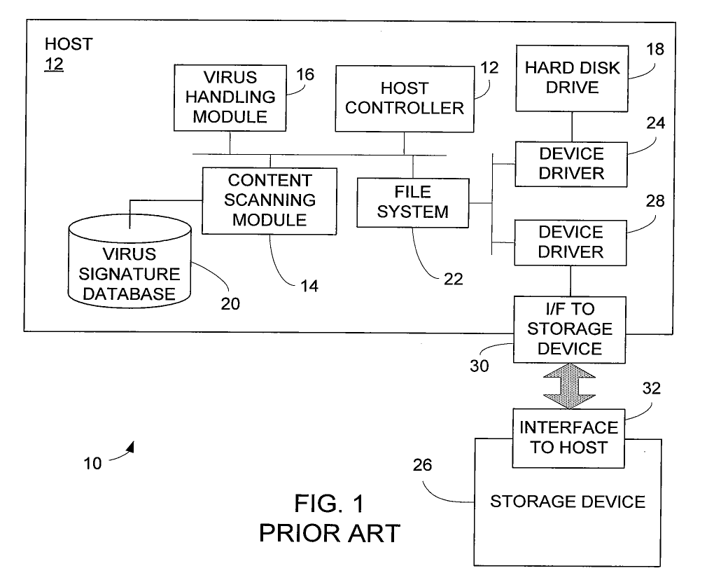

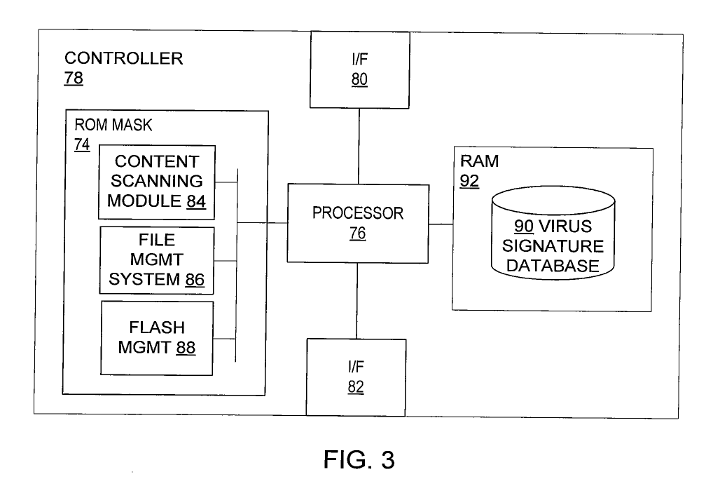

Many variations of the embodiment of FIG. 2 are possible. For example, instead of the logic and data for a content scanning module, a virus signature database, the flash management software, and a file management system being stored in flash memory when there is no power applied to the storage device, at least some of the logic instead may reside as firmware in a ROM mask of a controller as shown for example in FIG. 3. Here, a ROM mask 74 is accessible to a processor 76 of a controller 78, and similarly to the last embodiment the processor 76 communicates with a host of the storage device that has the controller 78 through an interface 80 and communicates with a flash memory through an interface 82. The processor 76 is configured to aid in the execution of the host's read, write, and erase operations on the files and to execute a content scanning module 84. In this embodiment, the content scanning module 84, a file management system 86, and a flash management system 88 are stored and executed in the ROM mask 74. During operation, a virus signature database 90 of this embodiment is loaded into a RAM 92 that is accessible to the processor 76. Alternatively, a virus signature database may reside in another storage device that is peripheral to the host. As still a further variant of the embodiment of FIG. 1, the logic of a content scanning module and a file management system resides in a separate ASIC that is external to the storage device controller but in communication therewith.

Thus, the controller may store logic associated with the invention, such as the logic for a content scanning module, a virus signature database, and/or a file management system, or, depending on the embodiment, the controller may access the logic from external sources. That is, although the controller 46 in FIG. 2 is depicted logically as having the internal processor 60, the ROM 62, and the RAM 64, a controller performing the same functions with analogous external elements may also be used in embodiments of the invention. The controller may additionally be any other equivalent means for aiding in the execution of the read, write, and erase operations on files.

Variations also of the content scanning module are within the scope of the invention. For example, the content scanning module may be configured to access a file system within a host for files to scan instead of accessing for that purpose a file management system that is internal to the storage device. The content scanning module may alternatively be any other equivalent means, configured for execution by the controller of the storage device, (1) for scanning files with reference to a virus signature database to find files infected with viruses and (2) for indicating the infected files to a virus handling module that resides external to the storage device.

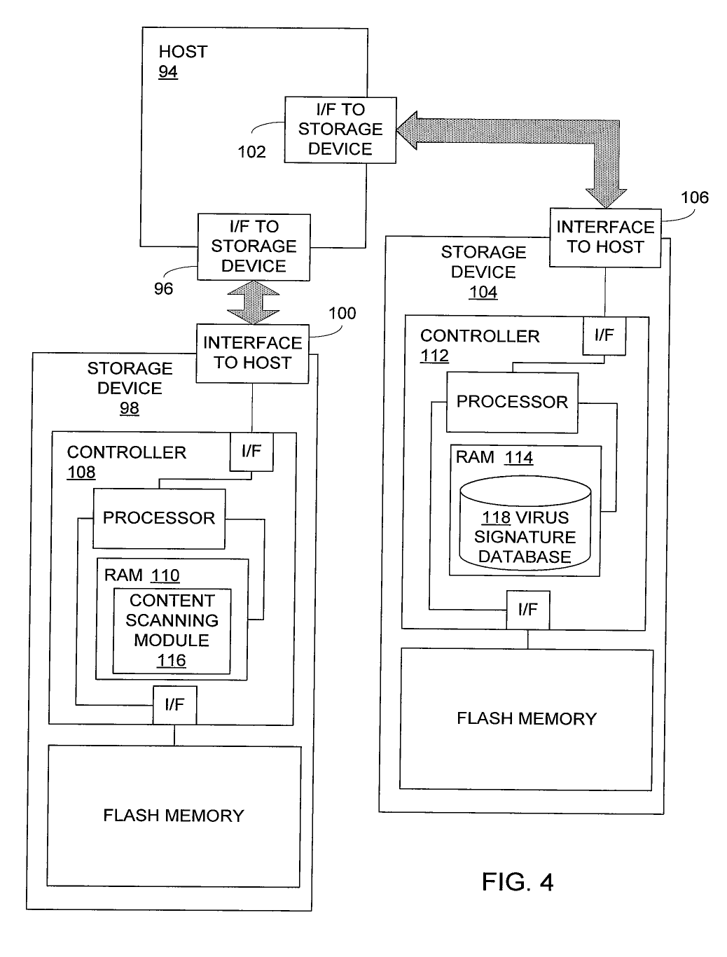

In the embodiment of FIG. 2, the virus signature database 49 referenced by the content scanning module 48 resides on the storage device 34 with the content scanning module 48, but in an alternate embodiment a virus signature database resides in a separate storage device. Such example embodiment is illustrated in FIG. 4. (For clarity, many of the elements analogous to those in FIG. 2 are not labeled and in some cases not shown.) A host 94 has an interface 96 for connecting to a storage device 98 at its interface 100 and another interface 102 for connecting to another storage device 104 at its interface 106. The storage device 98 has a controller 108 that has a RAM 110, and the storage device 104 has a controller 112 that has a RAM 114. The storage device 98 has a content scanning module 116 residing within its RAM 110, and the storage device 104 has a virus signature database 118 residing within its RAM 114. In operation, the content scanning module 116 of the storage device 98 references the virus signature database 118 of the storage device 104 when checking for viruses in the storage device 98.

Using the concept of allocating a separate storage device for maintaining a virus signature database for use by virus scanning modules on other storage devices reduces the amount of RAM space on those other storage devices needed for antivirus utilities. Thus, more RAM is available on those storage devices for other uses. In one scenario, a virus signature database is maintained on an SSD within its host, and multiple USB ports on the host allow the virus scanning modules of many portable storage devices such as UFDs to access the virus signature database. In a similar scenario, a virus signature database is maintained on a UFD.

In previously discussed embodiments, the storage devices being scanned for viruses have their own file management systems residing therein, but the invention is not limited accordingly. For example, it is within the scope of the invention that the file data within a storage device are reconstructed by the file system of the host to prepare the file for scanning by the content scanning module running in the storage device.

Also, although a flash memory is used in examples above embodying the invention, other types of non-volatile memory may be used, such as NOR flash. Even volatile memory or any other means for storing file data that are equivalents of the preceding memory types may be used without departing from the scope and spirit of the invention.

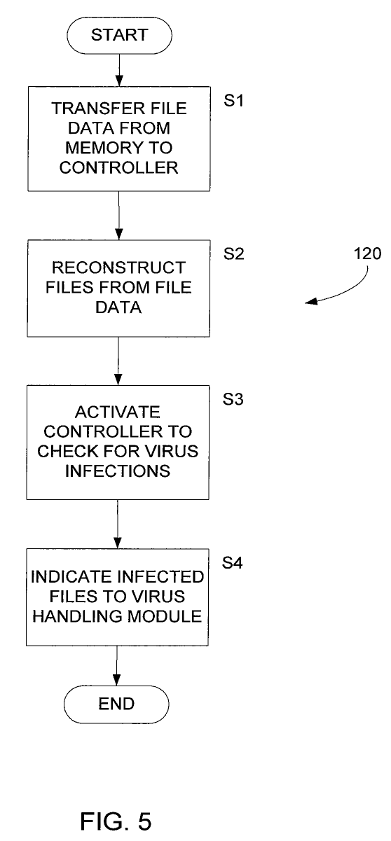

The invention may be embodied as a method of scanning for viruses within a storage device having a controller and a memory, which may be a non-volatile memory, such as a flash memory. The storage device 34 of FIG. 2 is an example of a storage device upon which this method may be performed. With reference to the flowchart 120 in FIG. 5, the method includes the step of transferring file data from the memory to the controller. (Step S1.) Logic within the storage device may be set to trigger this step when for example connecting the storage device to a host, when powering up/resetting the host with the storage device already attached, when applying power to the storage device, when sending a read, write, or delete command from the host, and when sending a specific transfer file data command from the host. The transfer file data command from the host may be time-based, which for example may be executed by the controller and originating within the storage device.

After Step S1 is completed, files are reconstructed from the file data that were stored in the memory. (Step S2.) The reconstructing of the files from the file data may be performed by the controller within the storage device, for example, by using the file management system 68 depicted in FIG. 2. Alternatively, the files may be reconstructed by the host using its file system of the host, or the files may be reconstructed using by another file system that is external to the storage device.

After Step S2, the controller is activated to check the files for virus infections. (Step S3.) For checking the files, the controller may use the content scanning module 48 of FIG. 2. In the process of checking the files, the controller may access a database of virus signatures that resides in the storage device or alternatively in another storage device that is separate from the host of the storage device having the controller.

Then, infected files, if any, are indicated to a virus handling module that is external to the storage device. (Step S4.) The virus handling module of this method is configured to alter access of host to the infected files, to modify the infected files, and/or to indicate to a user of the storage device the presence of the infected files. Above in the discussion of the virus handling module 70 examples are provided regarding how the virus handling module may process an infected file.

Having thus described exemplary embodiments of the invention, it will be apparent that various alterations, modifications, and improvements will readily occur to those skilled in the art. Alternations, modifications, and improvements of the disclosed invention, though not expressly described above, are nonetheless intended and implied to be within spirit and scope of the invention. Accordingly, the foregoing discussion is intended to be illustrative only; the invention is limited and defined only by the following claims and equivalents thereto.

We claim:

1. A storage device for a host having a host controller, the storage device comprising:
a memory configured to store file data;
a storage device controller configured to aid in the execution of read, write, and erase operations on files reconstructed from the file data; and
a content scanning module configured for execution by the storage device controller (1) to scan the files with reference to a database of virus signatures to find files infected with viruses and (2) to indicate the infected files to a virus handling module that resides external to the storage device,
wherein the virus handling module is configured to process the infected files by (1) altering access of the host to the infected files, (2) modifying the infected files, and/or (3) indicating the presence of the infected files.

2. The storage device of claim 1, wherein the memory is a non-volatile memory.

3. The storage device of claim 2, wherein the non-volatile memory is flash memory.

4. The storage device of claim 1 further comprising:
the database of virus signatures referenced by the content scanning module.

5. The storage device of claim 1, wherein the database of virus signatures referenced by the content scanning module resides in another storage device that is peripheral to the host.

6. The storage device of claim 1, wherein the virus handling module is configured to reside on the host and to be executed by the host controller.

7. The storage device of claim 1, wherein the virus handling module alters the access of the host to the infected files by deleting the infected files and/or by modifying the access rights of the infected files.

8. The storage device of claim 1 further comprising:
a file management system configured for utilization by the storage device controller to read sectors of the non-volatile memory and to reconstruct the files for the content scanning module to scan.

9. A storage device for a host having a host controller, the storage device comprising:
memory means for storing file data;
controller means for aiding in the execution of read, write, and erase operations on files reconstructed from the file data; and
content scanning means, configured for execution by the controller means, (1) for scanning the files with reference to a database of virus signatures to find files infected with viruses and (2) for indicating the infected files to a virus handling means that resides external to the storage device,
wherein the virus handling means is a means for processing the infected files by (1) altering access of the host to the infected files, (2) modifying the infected files, and/or (3) indicating the presence of the infected files.

10. The storage device of claim 9 further comprising:
the database of virus signatures referenced by the content scanning means.

11. The storage device of claim 9, wherein the database of virus signatures referenced by the content scanning means resides in another storage device that is peripheral to the host.

12. The storage device of claim 9, wherein the virus handling means is configured to reside on the host and to be executed by the host controller.

13. The storage device of claim 9 further comprising:
a file management means, configured for utilization by the controller means, for reading sectors of the memory means and for reconstructing files for the content scanning means to scan.

14. A controller for a storage device, the controller comprising:
a first interface for communication with a host of the storage device, the host having a host controller;
a second interface for communication with a memory that is configured to store file data;
a content scanning module configured (1) to scan files reconstructed from the file data with reference to a database of virus signatures to find files infected with viruses and (2) to indicate the infected files to a virus handling module that resides external to the storage device, the virus handling module being configured to process the infected files, the processing (1) altering access of the host to the infected files, (2) modifying the infected files, and/or (3) indicating to a user of the storage device the presence of the infected files; and
a processor configured (1) to aid in the execution of read, write, and erase operations on the files and (2) to execute the content scanning module.

15. The controller of claim 14, wherein the memory is a non-volatile memory.

16. The controller of claim 15, wherein the non-volatile memory is a flash memory.

17. The controller of claim 14 further comprising:
the database of virus signatures referenced by the content scanning module.

18. The controller of claim 14, wherein the database of virus signatures referenced by the content scanning module resides in another storage device that is peripheral to the host.

19. The controller of claim 14, wherein the virus handling module resides on the host and is executed by the host controller.

20. The controller of claim 14, wherein the virus handling module alters the access of the host to the infected files by deleting the infected files and/or by modifying the access rights of the infected files.

21. The controller of claim 14 further comprising:
a file management system configured for utilization by the processor to read sectors of the non-volatile memory and to reconstruct the files for the content scanning module to scan.

22. A method of scanning for viruses within a storage device having a controller and a memory, the method comprising:
transferring file data from the memory to the controller;
reconstructing files from the file data;
activating the controller to check the files for virus infections;
indicating infected files to a virus handling module that is external to the storage device,
wherein the virus handling module is configured to (1) alter access of a host of the storage device to the infected files, (2) modify the infected files, and/or (3) indicate to a user of the storage device the presence of the infected files.

23. The method of claim 22, wherein the reconstructing of the files from the file data is performed by the controller within the storage device.

24. The method of claim 22, wherein the memory is a non-volatile memory.

25. The method of claim 24, wherein the non-volatile memory is a flash memory.

26. The method of claim 22, wherein activating the controller to check the files for virus infections includes accessing a database of virus signatures that resides in the storage device.

27. The method of claim 22, wherein activating the controller to check the files for virus infections includes accessing a database of virus signatures that resides in another storage device that is separate from the host.
